(19) United States
(12) Patent Application Publication
(10) Pub. No.: US 2020/0240708 A1
(43) Pub. Date: Jul. 30, 2020

(54) FLAMELESS HEAT METHOD FOR DRYING OF STRUCTURES OF MOLD REMEDIATION

(71) Applicant: Douglas Mallonee, Mobile, AL (US)

(72) Inventor: Douglas Mallonee, Mobile, AL (US)

(21) Appl. No.: 16/671,562

(22) Filed: Nov. 1, 2019

Related U.S. Application Data
(60) Provisional application No. 62/754,354, filed on Nov. 1, 2018.

(51) Int. Cl. F26B 21/08; F26B 21/10; F26B 23/04; F26B 3/02; F24F 3/14

(52) U.S. Cl. CPC F26B 21/08; F26B 21/10; F24F 3/14; F26B 3/02; F26B 23/04

(57) ABSTRACT

The disclosure provides for a method of drying structures and of killing organisms within the structures. The method includes providing heated air within a structure. Prior to providing the heated air, the structure has a first moisture level and a first concentration of organisms. The method includes maintaining the heated air within a first temperature range within the structure for a first time period. The method includes ceasing the provision of the heated air to the structure. After ceasing the provision of the heated air to the structure, the structure has a second moisture level and a second concentration of organisms. The second moisture level is lower than the first moisture level, and the second concentration of organisms is lower than the first concentration of organisms.

### CROSS-REFERENCE TO RELATED APPLICATIONS

The present application claims the benefit of U.S. Provisional Patent Application No. 62/754,354 (pending), filed on Nov. 1, 2018, the entirety of which is incorporated herein by reference.

### FIELD

The present disclosure relates to systems and methods for drying structures, microorganism (e.g., mold, fungi) remediation, and blight reduction.

### BACKGROUND

The growth and propagation of mold within structures is a health hazard. Typically, the impact of a hurricane or other major storm causes many structures in the area of impact, including residential, commercial, and industrial structures, to become at least temporarily saturated with flood, rain water, and/or waste water (also referred to as black water, such as septic water). This inundation of moisture on and/or into the structure facilitates the growth and propagation of mold, including black mold, on and within the structure. The presence of such mold can result in allergies and other ailments to those in proximity to the mold. For example, breathing air with mold or mold spores can result in any of various respiratory ailments.

Additionally, the presence of mold contributes to blight in communities, which decreases property values and decreases public health. The occurrence of mold is prominent in wet environment communities, such as coastal and/or wetlands communities that are at or near sea-level, such New Orleans.

In addition to health issues and general blight, mold can also cause structural damage to building materials, such as materials that absorb water.

It would be desirable to have a safe, efficient, fast, and environmentally friendly method to dry structures and kill mold, mold spores, and other pests and organisms.

### BRIEF SUMMARY

One embodiment of the present disclosure includes a method of drying a structure and of killing organisms within the structure. The method includes providing heated air into a structure. Prior to providing the heated air into the structure, the structure has a first moisture level and a first concentration of organisms or spores. The method includes maintaining the heated air within a first temperature range within the structure for a first time period. The method includes ceasing the provision of the heated air into the structure. After ceasing the provision of the heated air into the structure, the structure has a second moisture level and a second concentration of organisms or spores. The second moisture level is lower than the first moisture level, and the second concentration of organisms or spores is lower than the first concentration of organisms or spores.

Another embodiment of the present disclosure includes a system for drying a structure and killing organisms within the structure. The system includes a source of heated air, and a conduit. The conduit is configured to couple with a structure. The conduit is in fluid communication with the source of heated air and is configured to receive heated air from the source of heated air and provide the heated air into the structure.

### BRIEF DESCRIPTION OF THE DRAWINGS

So that the manner in which the features of the compositions, products, articles, apparatus, systems and methods of the present disclosure may be understood in more detail, a more particular description of the concepts briefly summarized above may be had by reference to the embodiments thereof which are illustrated in the appended drawings that form a part of this specification. It is noted, however, that the drawings illustrate only various exemplary embodiments and are, therefore, not to be considered limiting of the disclosed concepts as it may include other effective embodiments as well.

FIGS. 1A-1I are tables of various organisms that may be killed using the present method.

FIG. 2 depicts one exemplary heating device that may be used in the present method.

FIG. 3 is a simplified flow chart of a method.

FIGS. 4A-4J are tables of various organisms that may be killed using the present method.

FIG. 5 is a schematic of a structure being treated.

Compositions, products, articles, apparatus, systems, and methods according to present disclosure will now be described more fully with reference to the accompanying drawings, which illustrate various exemplary embodiments. Concepts according to the present disclosure may, however, be embodied in many different forms and should not be construed as being limited by the illustrated embodiments set forth herein. Rather, these embodiments are provided so that this disclosure will be thorough as well as complete and will fully convey the scope of the various concepts to those skilled in the art and the best and preferred modes of practice.

### DETAILED DESCRIPTION

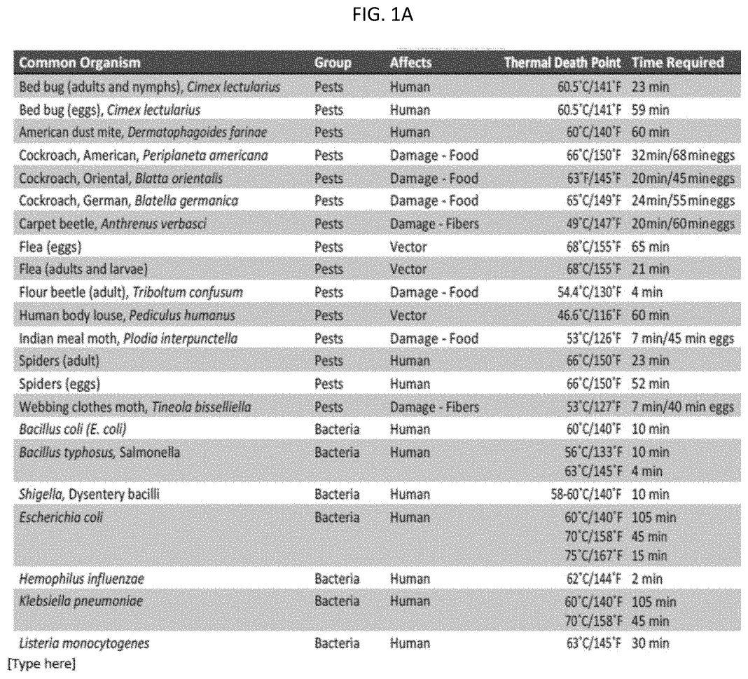

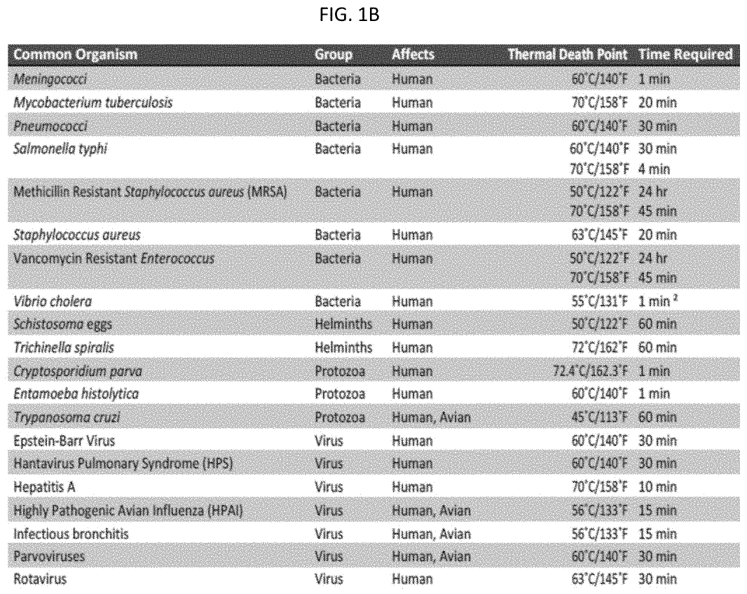

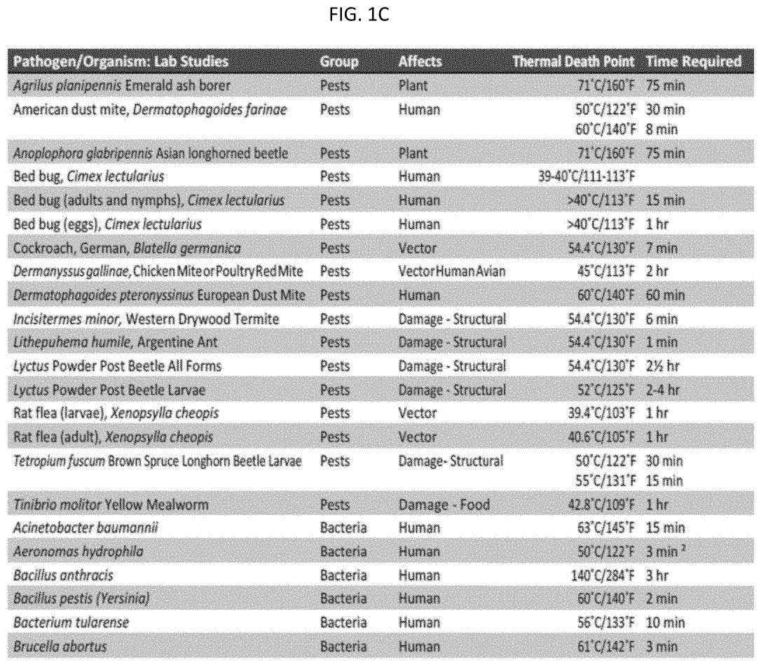

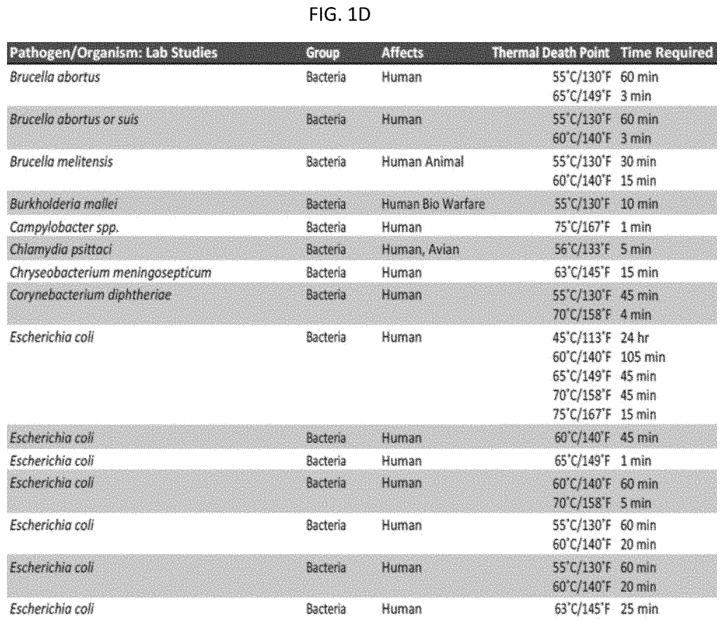

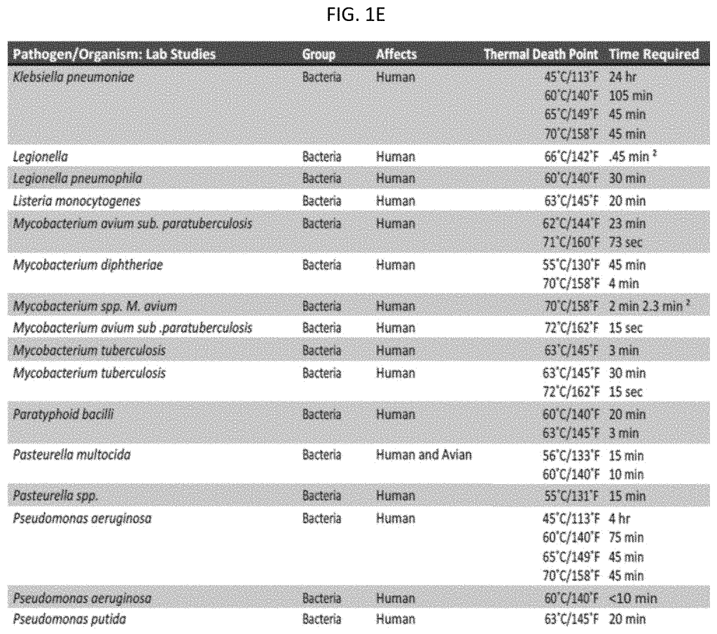

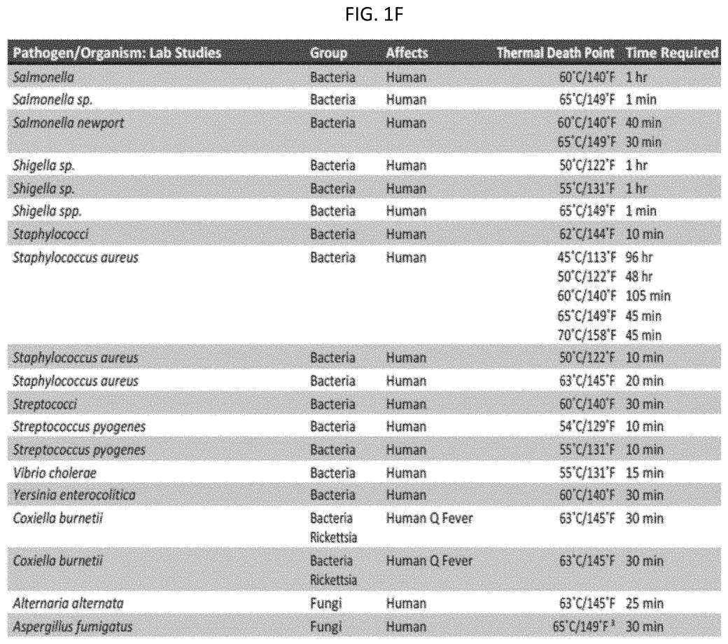

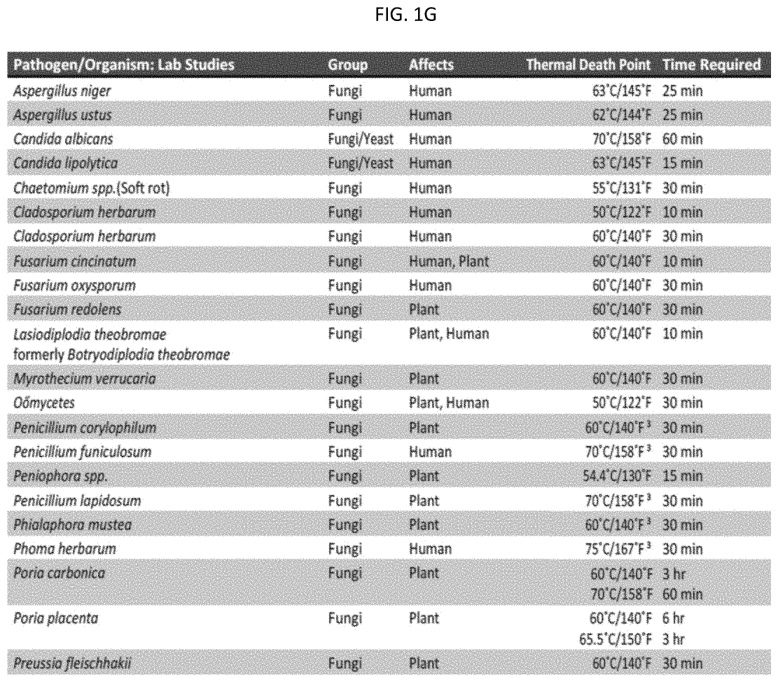

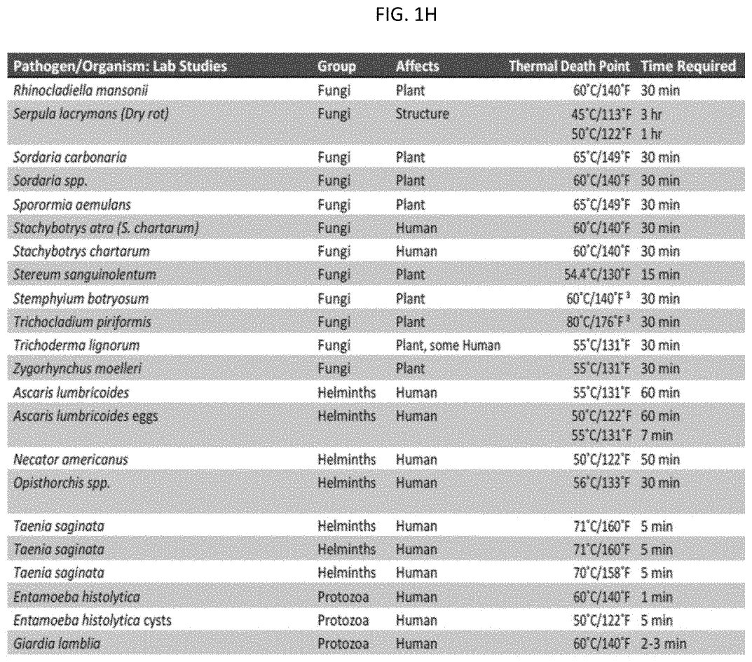

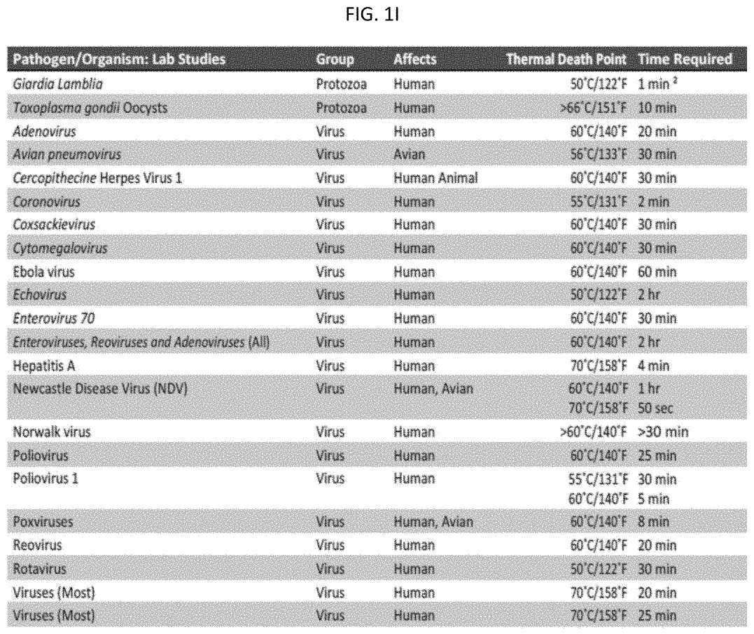

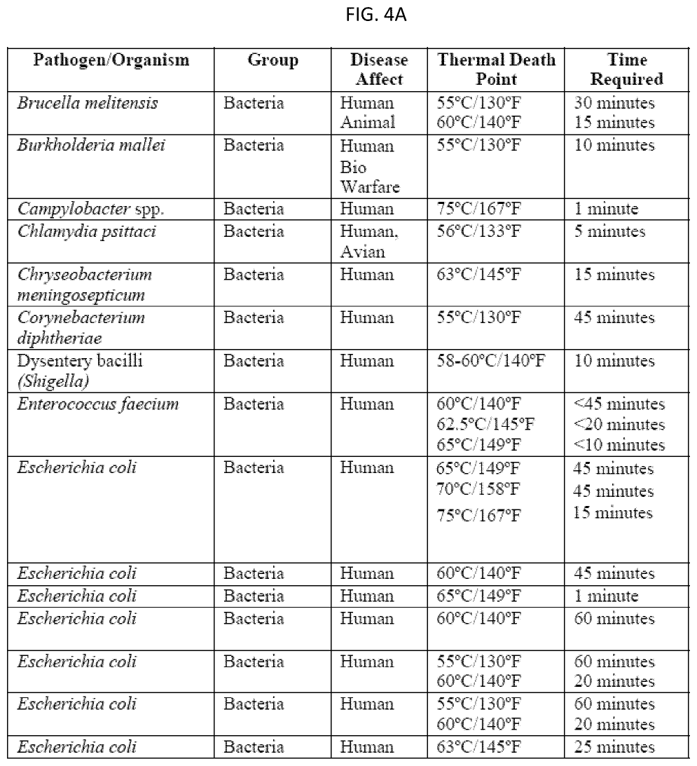

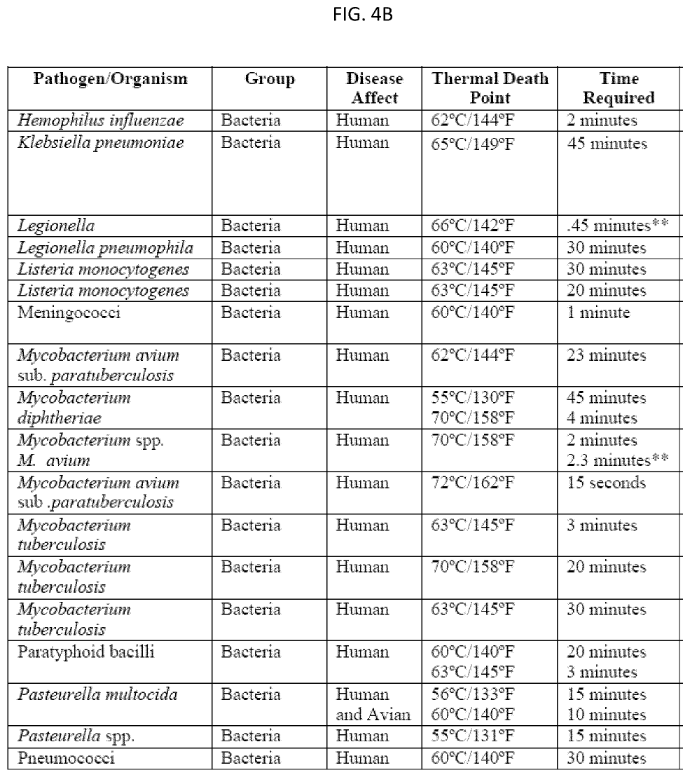

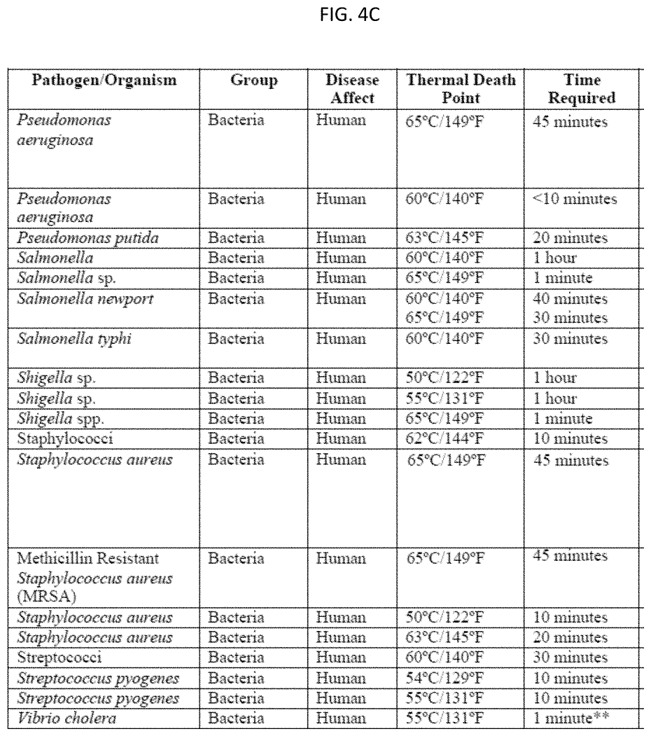

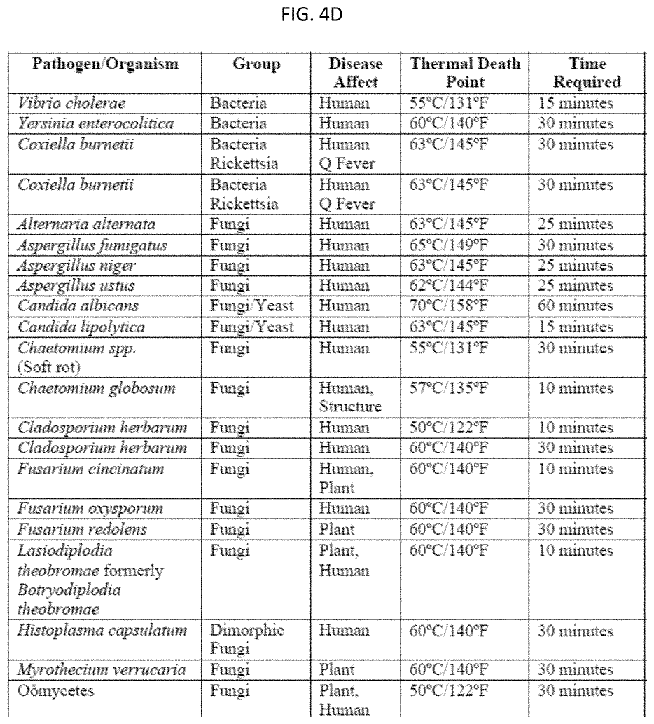

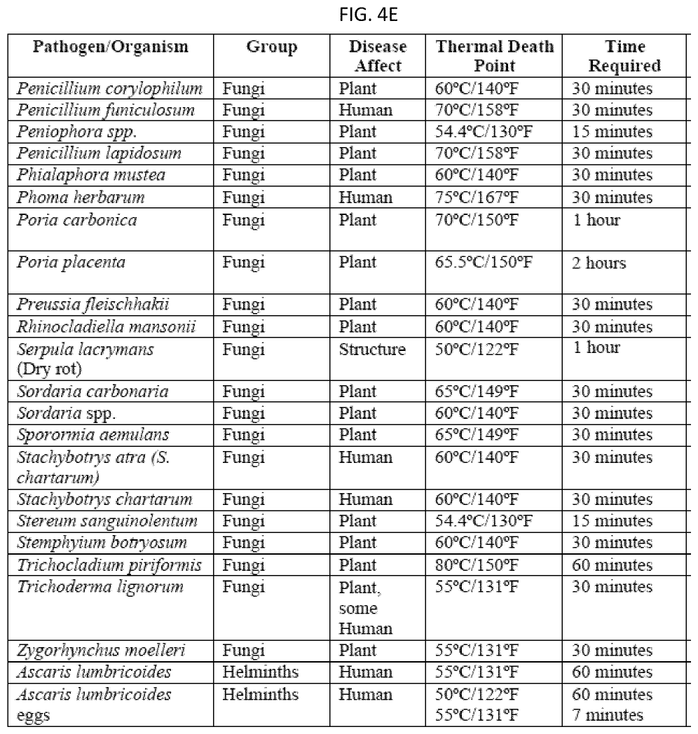

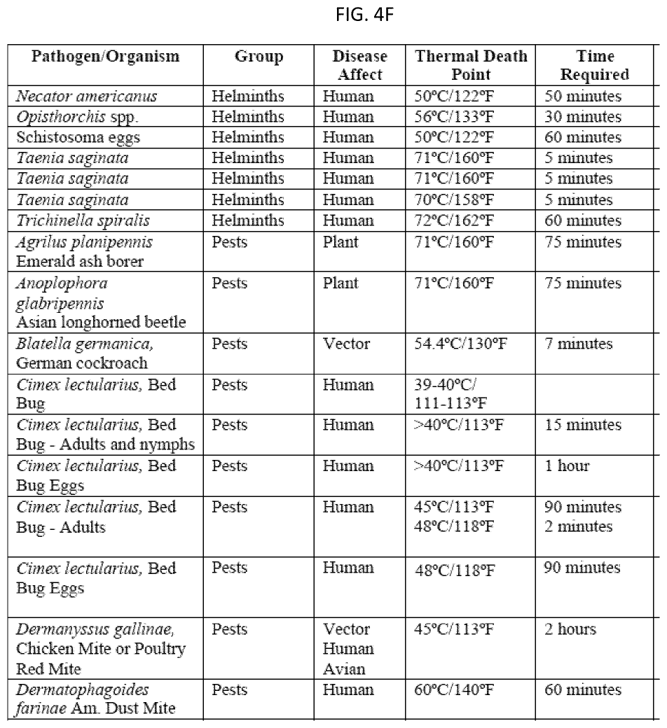

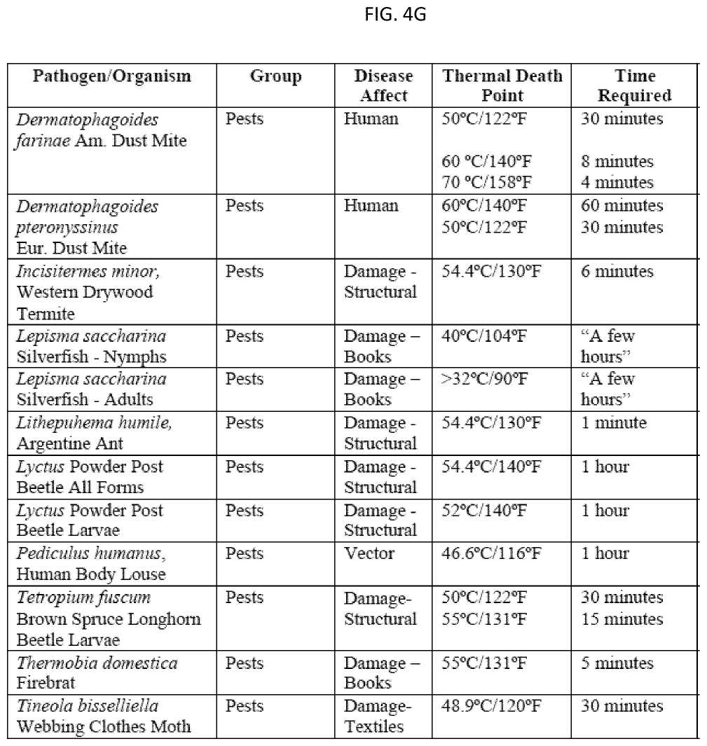

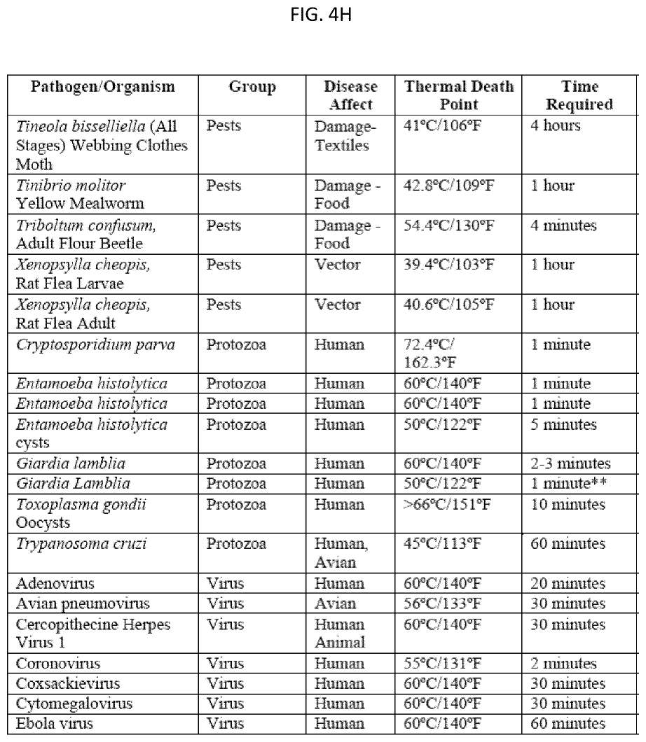

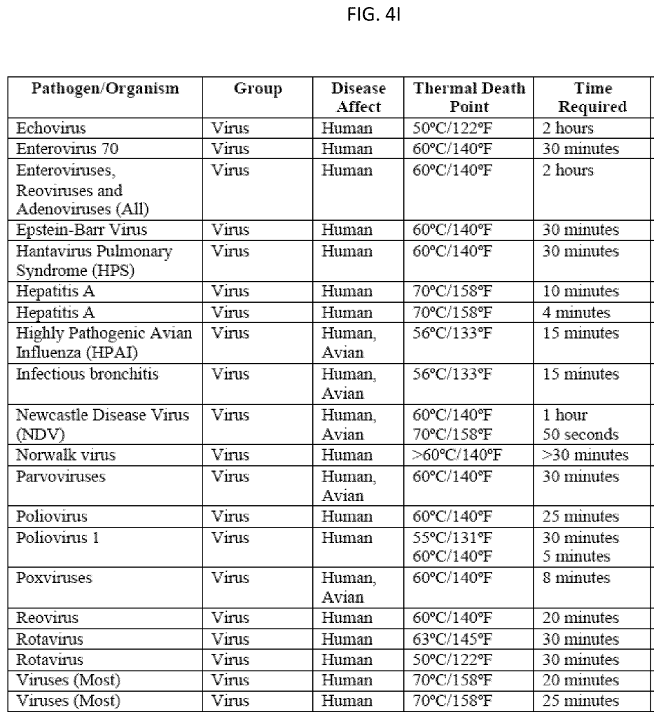

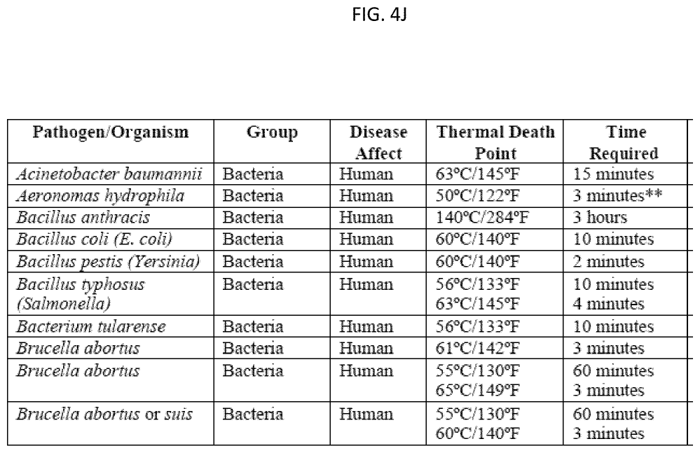

The present disclosure provides for systems and methods of drying structures and of killing organisms undesirably inhabiting the structures. As used herein the organisms may include, but are not limited to, mold and spores thereof, pests (e.g., insects), bacteria, viruses, fungi, yeast, helminths, and protozoa. For example, and without limitation, in some such embodiments, the present methods may be used to kill any one or more of the common organisms or pathogen/organisms listed in the first column in the Tables of FIGS. 1A-1I and in FIGS. 4A-4J. In some embodiments, the method is used to kill organism having a thermal death point of up to 284° F., or up to 210° F., or from 100° F. to 280° F., or from 110° F. to 270° F., or from 120° F. to 260° F., or from 130° F. to 250° F., or from 140° F. to 240° F., or from 150° F. to 230° F., or from 160° F. to 220° F., or form 170° F. to 210° F., or from 180° F. to 200° F.

In some such embodiment, the methods disclosed herein include the use of “flameless heat” to both dry structures, such as houses, and kill undesirable organisms, such as mold or other organisms infesting a structure (e.g., as a result of a natural disaster, such as a hurricane. As used herein, “flameless heat” refers to heat produced without the use of a flame. In some embodiments, the methods disclosed herein may produce heat using a microturbine jet engine or microturbine heater, such as the JetHeat GT 1400 available from JetHeat LLC, and/or such as the technology described in U.S. Pat. Nos. 6,073,857; 6,161,768; 6,679,433; 8,327,644; 6,679,433; 6,073,857; 6,161,768; and 8,327,644, the entireties of each of which are incorporated herein by reference. Some such microturbine jet engines are capable of delivering large quantities of heat at a relatively low cost, while providing for relatively environmentally friendly operation and requiring minimal maintenance. In some embodiments, such microturbine jet engines are capable of a heat output equivalent of from 800,000 to 1,400,000 BTUs, or from 900,000 to 1,300,000 BTUs, or from 1,000,000 to 1,200,000 BTUs. In some embodiments, such microturbine jet engines are capable of a heat output equivalent of greater than 1,400,000 BTUs or less than 800,000 BTUs. In some aspects, the microturbine jet engines exhibit relatively low fuel consumption that produces heat (e.g., flameless heat), and reduces overall treatment time by from 50%-60% compared to traditional mold treatment methods. In certain aspects, the microturbine jet engine used in the present methods are carbon neutral or substantially carbon neutral, and do not produce or emit greenhouse gasses, such as NO_{X} and SO₂. The low-fuel consumption of the microturbine jet engine also contributes to substantially less CO₂ generation.

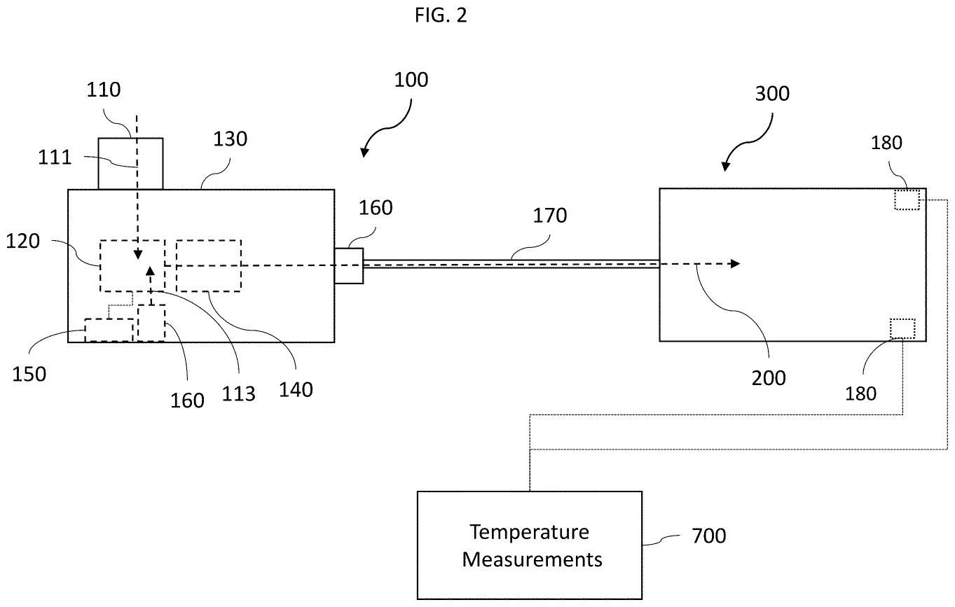

FIG. 2 depict a microturbine jet engine suitable for use in at least some aspects of the present methods. Microturbine jet engine 100 includes top inlet 110. In some embodiments, top inlet 110 is configured to provide noise attenuation. For example, in some aspects, about 81 decibels are emitted at the operation controls during use of microturbine jet engine 100. Microturbine jet engine 100 includes housing 130, such as a steel box.

Microturbine jet engine 100 includes turbine engine 120. In some embodiments, microturbine jet engine 100 includes catalyst technology 140 positioned in the exhaust stream of turbine engine 120, which provides for increased thermal efficiency and clean-burning engine heated air in accordance with OSHA and NIOSH standards.

Microturbine jet engine 100 includes microprocessor control 150, such that microturbine jet engine 100 is relatively easy to use and control through intuitive design. Microprocessor control 150 provides a digital automatic control system that directs engine speed and heat output of microturbine jet engine 100. Microprocessor control 150 may be in data communication with jet engine 120 for control thereof. Microturbine jet engine 100 may include multiple heat settings, such as three heat settings, including a high-heat at 5.3 GPH, 5200 CFM; a medium-heat setting at 4.0 GPH, 4000 CFM; and a low-heat setting at 3.2 GPH, 3200 CFM. Microprocessor control 150 may operate to monitor the system functions of microturbine jet engine 100, provide fail-safe programming to improve operator safety, and may include onboard diagnostic software for diagnosing conditions of the turbine engine 120.

Microturbine jet engine 100 includes exhaust 160. In some embodiments, exhaust 160 is capable of exhausting over 5,200 CFM of heated air with 185-degree temperature rises at 0 degrees Fahrenheit. Exhaust 160 may move heated air over relatively long distances. For example, turbine engine 120 may expel heated air through exhaust 160 to a distance of up to 500 feet through exhaust conduit 170 coupled with exhaust 160. Exhaust conduit 170 may be rigid or flexible ducting, tubing, piping, or other conduit. For example, in some embodiment, when exhaust conduit 170 is flexible ducting, the heated air may be expelled from exhaust 160 to a distance of 200 feet from exhaust 160, and when exhaust conduit 170 is rigid ducting, the heated air may be expelled from exhaust 160 to a distance of 500 feet from exhaust 160.

Microturbine jet engine 100 may include an integrated fuel tank 161 that provides fuel to turbine engine 120. For example, tank 161 may supply a volume of fuel sufficient to provide up to 60 hours of continuous operation of engine 120. In some embodiments, the fuel of the engine is diesel vapors, rather liquid fuel.

Microturbine jet engine 100 may be a compact, self-contained unit, simplifying tow rig requirements. For example, engine 100 may, in some embodiment weigh 4,000 lbs, including the weight of the fuel. The compact, self-contained structure of engine 100 may improve the maneuverability of the engine 100. In some embodiments, housing 130 may be mounted on a trailer (not shown) for mobility thereof, and may include electric brakes with breakaway safety.

As shown in FIG. 1, air 111 enters turbine engine 120 through inlet 110, and fuel 113 enters engine 120 from tank 161. Within engine 120, fuel 113 and air 111 are combusted and drive engine 120 in accordance with processes well known to those skilled in the art, forming exhaust, referred to herein as heated air 200. Heated air 200 passes through the exhaust of engine 120, which here includes catalyst technology 140, passes through exhaust 160 of engine 100, passes through exhaust conduit 170 and enters structure 300 (e.g., a house).

Exhaust conduit 170 may be flexible or rigid conduit that is coupled with exhaust 160 and extends into an exterior of structure 300 and/or portions of the structure 300 (e.g., into the crawlspace of a house). Thus, heated air 200 flows from microturbine jet engine 100 into and/or onto structure 300. The heated air 200 is brought to a desired temperature and is provided into and/or onto the structure 300 for a time period that is sufficient to kill one or more organisms, such as mold. For example, Tables 1A-1I of FIGS. 1A-1I and FIGS. 4A-4J list various thermal death points and time durations required for killing various organisms. For example, and without limitation, the heated air may be at a temperature of up to 284° F., or up to 210° F., or from 100° F. to 280° F., or from 110° F. to 270° F., or from 120° F. to 260° F., or from 130° F. to 250° F., or from 140° F. to 240° F., or from 150° F. to 230° F., or from 160° F. to 220° F., or form 170° F. to 210° F., or from 180° F. to 200° F. The heated air may be provided to the structure for any desired amount of time, such as for a time ranging from 15 seconds to 96 hours, or for any time range there-between. The temperature and time required will vary depending upon the organism(s) to be killed, and may vary from those provided above.

In some aspects, one or more sensors 180 are positioned in and/or on the structure 300 to monitor the temperature therein or thereabout. For example, the sensors may be positioned in one or more rooms within the structure (e.g., in each room), in an attic of the structure, in a basement of the structure, a crawlspace of the structure, or combinations thereof. The sensors may be thermocouples, and may be in data communication with a remote monitoring device 700 that is external to the structure 300 for sending temperature measurement data thereto, such that the temperature within and/or about the structure may be monitored during operations. For example, remote monitoring device 700 may be a mobile phone, a computer, or a tablet. In some aspects, the remote monitoring device 700 is capable of capturing thermal images of the structure, such as a thermographic camera. The one or more sensors 180 may also include moisture level sensors.

The heated air 200 may function to kill mold, mold spores, and other species within or about structure 300, preventing the organisms from reproducing or sporulating after treatment. Because organisms are killed based on the thermal death points, there is no need to remove entire walls to kill the organisms that are located in difficult to reach places. The treatment can be carried out for a time sufficient to ensure that all areas of structure 300, including within the walls, have reached the thermal death point for a sufficient length of time to result in death of the organism. As every living organism has a thermal death point, the process for killing, for example, bed bugs, may also be used to kill and/or completely eradicate other organisms, such as mold. Generally speaking, treatments with air temperatures of about 66° C./150° F. for 2 hours will be lethal for most organisms. In one laboratory test, it was found that nearly all metamorphic stages of insects died at 120° F. in 30 minutes or less, except for the egg stage. The eggs required an hour at this temperature. In some such aspects, the method is environmentally friendly, flameless, and does not include the use of treatment chemicals. Some structures may require from 24 to 48 hours for successful treatment.

In some aspects, the method utilizes turbulent air flow of the heated air within the structure to facilitate heating throughout the structure.

In other aspects, the method includes the use of heat generated via magnetics to heat the structures (e.g., magnetic heat friction), heat generated via a microturbine engines as described above, heat generated via jet engine exhaust, or another flameless heat source. In some aspects, the method is capable of forming rapid temperature rises, increasing static pressure within the structure, and increasing CFM within the structure.

In addition to killing organisms, the method may be used to rapidly dry the structure 300. In some embodiments, the method reduces the moisture content within the structure to below 20%, or below 19%, or below 15%. The method may be used to reduce the relative humidity within a structure to less than 50%, optionally within a time frame of less than 48 hours.

In some aspects, the method includes the use of hypofiltration. In other aspects, the method does not include the use of hypofiltration.

### Preparing a Structure for Treatment

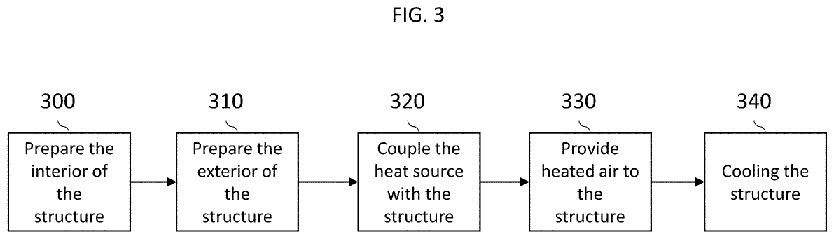

During the heating process, temperatures of the heated air may range from, for example, 140 degrees to 180 degrees Fahrenheit. The heated air may provide a constant, dry, flameless heat within the structure. Such temperatures are lethal to mold, bacteria, viruses and insects. As shown in box 300 of FIG. 3, in some aspects of the method includes preparing the interior of the structure. Preparing the interior of the structure may include removing certain contents within the structure prior to the heating process, such as to avoid damage thereof. Furthermore, in some such aspects of the method, humans are prevented from entering the structure to prevent injury or death during the heating process. Some examples of things that may be removed from the structure prior the heating process include, but are not limited to, plants, fish, reptiles, other animals or pets; candles, wax, crayons, lipstick, cosmetics and other items that could melt; medicines and vitamins; aerosol cans (e.g., hairspray, insect repellant, asthma inhalers, cleaning products, etc.), fire extinguishers, and other combustible items or pressurized items (e.g., lighters, propane, etc.); firearms and ammunition; oil paintings and acrylic paintings; fresh fruit and vegetables, chocolates, food that can melt, carbonated beverages, alcohols, wines, and liquors; antique furniture with finish or fragile glue points, plastic blinds, vinyl blinds; musical instruments and collectibles may be heat sensitive, such as guitars, vinyl records; other items, such as taxidermy mounts, plastic blinds, batteries, photographs or photo negatives, family heirlooms and irreplaceable items of concern, any items that could be damaged by constant temperatures ranging from 140 to 180° F.

Preparing the interior of the structure may include wrapping articles that are impractical to remove. Articles may be wrapped in heat protective devices, such as thermally insulated blankets, Styrofoam board, insulation boards (such as FOAMULAR by Owens Corning), or other insulating materials or heat protective barriers, for example. The articles may be wrapped in an insulating material to protect the articles from damage. Some small items, such as medicines, food, and cosmetics, may be placed in a refrigerator.

Preparing the interior of the structure may include unplugging appliances in the structure. For example, in some embodiments refrigerators may be unplugged prior to the heat treatment.

Preparing the interior of the structure may include moving contents within the structure away from the walls of the structure. For example, all furniture and other belongings may be moved a minimum of 1-3 feet away from the walls. All items, such as pictures, wreaths, décor, and knickknack shelves, may be removed from the walls as well. In some embodiments, the heat treatment is a non-invasive process, such that the method is implemented without removal wall material, such as sheetrock, floor materials, such as tiles, and ceiling material, such as sheetrock.

Preparing the interior of the structure may include disengaging sprinkler systems and removing the sprinkler heads therefrom. Preparing the interior of the structure may include turning or removing rubber-backed rugs and/or foam rubber mats from floor. Preparing the interior of the structure may include ensuring that drawers and linen closets are at most loosely filled, and are not packed tightly with items. Items may be moved off of the floors and into closets. Clothing may be left hanging in closets, spaced apart to facilitate with heat distribution. As clothes hangers may get hot, heat-sensitive fabrics may be protected. Water beds may be drained, air beds may be deflated, electric wall socket covers may be removed for treatment application access to interior wall space. Batteries may be removed from smoke detectors. Air conditioners and fans may be turned off, and electronics may be unplugged. Heat sensitive items that will remain in the structure during the heat treatment may be covered with heat barriers (such as thermally insulating blankets or Styrofoam boards). Some such items include vinyl windows, electrical outlet covers, AC registers, appliances, and any personal property that can be damaged by heat. For example, flat screen televisions and computers may be covered, such as with a clean towel or blanket. A window may have a Styrofoam board press fit thereon, and a blanket attached thereover. Another component that may have a heat barrier installed thereon is an AC register. An AC register may be covered by a Styrofoam box, optionally composed of multiple Styrofoam boards coupled together (e.g., with tape). Another component that may have a heat barrier installed thereon is an electrical outlet, which may be covered by a Styrofoam board, optionally coupled via tape.

The method may include preparing the exterior of the structure, as shown by box 310 of FIG. 3. Preparing the exterior of the structure may include closing all doors, windows, and other access points into the structure. In some embodiments, the openings in the structure may be sealed, such as with plastic.

The method may include coupling the heat source (e.g., engine 100) to the structure, as shown by box 320 in FIG. 3. For example, the exhaust conduit may be coupled between the heat source and the structure. The exhaust conduit may be couple with or through a window or doorway. In some embodiments, the coupling between the exhaust conduit and the structure may be sealed to reduce leakage of heated air from within the structure. Prior to providing the heated air, it is ensured that all entrances to the structure are secured to prevent unauthorized access.

The method may include providing heated air to the structure, as shown by box 330 in FIG. 3. The heated air may be provided at a temperature and for a period of time that is sufficient to kill the target pests, dry the structure, or combinations thereof.

In some embodiments, fans or other devices are positioned within the structure to create turbulent flow (a tornado effect) within the structure to disperse the heated air therein. In some embodiments, heat sensors and/or moisture sensors are positioned within the structure and are monitored during the heat treatment, such as from a remote device in communication with the sensors. The sensors, fans, and heat barriers may be visually inspected, such as every ten minutes, and the temperatures and/or moisture levels may be recorded regularly, such as every ten minutes, and logged into a log book or software program. In some embodiments, the temperature is maintained between 165-175 degrees Fahrenheit for at least 1 hour.

In some embodiments, the heat source (e.g., microturbine) may include an emergency shut off switch. During the heat treatment, a minimum of two workers may be on site at all times, and a working communications system between the heater operator and an interior technician may be maintained. The heater operator (person operating the heat source) may remain within 5 feet of heater shut off switch in case emergency shut off is required.

The method may include cooling the structure, as shown by box 340 in FIG. 3. For example, after treatment of the structure, the structure may be cooled prior to reentry. The structure may be cooled to a temperature that is safe for the reentry of people, pets, and/or contents. In some embodiments, the structure is cooled to 90 degrees Fahrenheit. After cooling, the heat barriers, fans, and sensors may be removed from the structure, and the structure may be cleaned. For example, cleaning the structure may include cleaning each surface of the structure, vacuuming the structure with a HEPA vacuum, followed by cleaning the surfaces with a cleaner (e.g., an S1 cleaner), cleaning bare building materials with a cleaner (e.g., an S2 cleaner), and then fogging the structure with a cleaner (e.g., an S3 cleaner). Once cleaning is finished, air scrubbers (e.g., negative air machines) may be operated to scrub the air for a time, such as 24 hours.

In some embodiments, the method may be used to reduce and/or prevent blight in neighborhoods, such as by improving environmental conditions within structures, improving air quality conditions within structures, and improving health and safety conditions within structures.

In some embodiments, the heat treatment is implemented without the use of hazardous chemicals. That is, the organisms are killed without the use of hazardous chemicals. In some such embodiments, the heat treatment method kills pests, reduces the moisture content to less than 19%, reduces the relative humidity to less than 50%, reduces the levels of mold, virus and bacteria, or combinations thereof.

In some embodiments, the method includes performing structural pasteurization of the structure. In structural pasteurization, the temperature within and/or of the structure reaches a targeted temperature that results in microorganism death. In some such embodiments, the heated air is provided into the structure at a relatively high positive air pressure of up to 20 inches of static pressure, or from 2 to 20 inches of static pressure, or from 3 to 18 inches of static pressure, or from 5 to 15 inches of static pressure. The heated air may be provided into the structure at a static pressure that is sufficient to provide for the penetration of the heated air into the structure (e.g., into the walls and other building materials) to result in the thermal death of the target organisms. The normal static positive pressure an HVAC system is, for example, from 0.5-1.0 inches of static pressure. The relatively high positive pressure of the heated air pushes the heat and/or heated air throughout the structure and also pushes dead organisms out of the structure. Negative air pressure machines do not pasteurize the structure. However, in some embodiments, negative air pressure machines may be used to filter the air in the structure to remove dead organisms. Negative air pressure machines can use filters, including HEPA filters down to 0.1 micron.

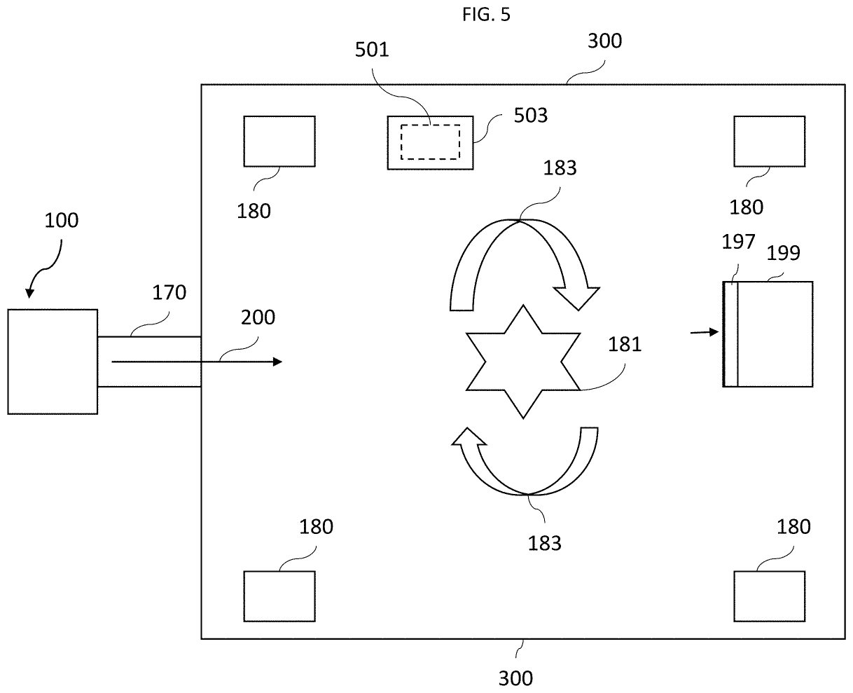

FIG. 5 depicts a schematic of a structure during heat treatment. As shown heated air 200 is provided into the localized environment of structure 200. Sensors 180 are positioned throughout the structure 200. Also fan 181 is positioned within structure 200 to create turbulent flow 183 of heated air within structure 200. Article 501 is protected from heat via heat protective device (e.g., a thermal blanket or other insulating material). Air 197 may be filtered through filters 197 of a negative pressure machine 199. In some embodiments, the air is exhausted from the machine 199 into the structure (also referred to as air scrubbing). In other embodiments, the air is exhausted from the machine 199 outside of the structure 200, creating a negative air pressure within the structure. The use of the machine 199 may occur after the provision of the heated air 200 is completed.

### EXAMPLES

### Example 1

An experimental case study of the heat treatment method was performed at in a structure. Exterior thermal images views of the structure during heating were captured. During the heat treatment method, temperatures of greater than 160° F. were attained to reach the thermal death points of the target organisms. Constant temperatures ranging between 160° F. and 190° F., for a period of 3 hours, were attained to cause thermal death of the organisms. Prior to the heat treatment, penicillium/aspergillus spore concentrations were found to range from 3,547 to 5,227 spores/M³ within the structure. The levels of penicillium/aspergillus spore concentrations in the structure after the heat treatment was from 0 to 27 spores/M³. Thus, the present method was found to be effective. Table 1, below, presents the data from the test.

TABLE 1
Data from Example 1

| | | Spores/M³ | Spores/M³ |
|---|---|---|---|
| | Spores/M³ | (inside back | (inside office |
| Fungi ID | (outside control) | area) | east) |
| penicillium/aspergillus- | 213 | 5,277 | 3,547 |
| pre-treatment level | | | |
| penicillium/aspergillus- | 160 | 27 | 0 |
| post-treatment level | | | |

As is evident from Table 1, the present method successfully reduced the organism and spore levels.

### Example 2

A moisture damage and mold assessment was completed at another facility. Upon inspection, moisture and mold was visually present on the ceilings, structure and multiple walls throughout the facility. The moisture content was greater than 19% throughout the facility, and ranged between 26%-31%. Without being bound by theory, it is believed that a moisture content of greater than 19% and/or a relative humidity of greater than 60% or 70% provides an environment that is conducive to mold growth if the structure is not dried within 24 to 48 hours of the occurrence of the moisture content and/or humidity exceeding these limits. Furthermore, when mold is determined to be present in a facility, the mold can have a negative impact on human health to those individuals residing or working inside the facility.

Based on the damage and mold assessment and visual inspection, the following treatment process was recommended. Prior to heat treatment, it was recommended to: (1) fix the underlying water/moisture sources, including repairing the roof (portal of entry) and any other structural moisture problems; (2) remove all saturated insulation, sheetrock and ceiling/tiles; and (3) have independent lab testing and analysis conducted. The treatment steps recommended included: (4) cleaning and sanitizing the entire facility; (5) drying of entire facility to less than 19% moisture content; (6) performed structural pasteurization with positive and negative pressure; and (7) perform HEPA vacuuming, HEPA filtration, moisture monitoring, and thermal monitoring of the structure. After the treatment, it was recommended to perform testing and analysis to confirm the successful mold treatment.

### Example 3

An apartment complex was assessed for moisture damage and mold presence. Upon inspection, the moisture and mold were visually present on the ceilings, structure and multiple walls throughout the facility. The moisture content was greater than 19% throughout the facility, and ranged between 23%-99% in the apartment units.

Based on the damage and mold assessment and visual inspection, the following treatment process was recommended. Prior to heat treatment, it was recommended to: (1) fix the underlying water/moisture sources, including repairing the roof (portal of entry) and any other structural moisture problems; and (2) remove all saturated insulation, sheetrock, carpet, and ceiling/tiles. The treatment steps recommended included: (3) perform HEPA vacuuming and anti-fungal microbial sanitizing of each apartment unit; (4) perform structural pasteurization of each apartment unit using up to 20 inches of static pressure-positive air flow reaching microbial thermal death points; (5) continual moisture monitoring and thermal monitoring (using infrared) of each apartment unit during treatment; and (6) air scrubbing and HEPA filtration of each apartment unit. After treatment, it was recommended that testing and analysis be performed. For each occupied apartment unit, a pre-treatment checklist should be provided to the resident to properly prepare the occupied unit for treatment (e.g., removal of furniture and other pre-treatment steps discussed elsewhere herein).

### Example 4

Another apartment complex was assessed for moisture damage and mold presence. Upon inspection, the moisture and mold were visually present on the ceilings, structure and multiple walls throughout the facility. The moisture content was greater than 19% throughout the facility, and ranged between 23%-25% in the apartment units. The pre-treatments steps recommend for this apartment included: (1) Repair of the underlying water/moisture sources, such as repair of the roof (portal of entry) and/or any other structural problems creating the moisture intrusion; (2) preparation of the apartment units prior to treatment utilizing a heat sensitive items check list and utilizing heat protective devices (insulating covers) when necessary; and (3) performance of independent pre-treatment lab testing.

The treatment procedure recommended for this facility included: (4) general cleaning prior to treatment of each apartment unit; (5) HEPA vacuuming, and anti-fungal/microbial sanitizing of each apartment unit; (6) drying of each apartment unit to less than 19% moisture content; (7) reducing the relative humidity in each apartment unit to less than 50%; (8) structural pasteurization of each apartment unit utilizing up to 20 inches of static pressure-positive air flow reaching microbial thermal death points; (9) continual moisture monitoring during treatment; (10) thermal monitoring imagery of each apartment unit during treatment; (11) air scrubbing and HEPA filtration of each apartment unit; and (12) surface and air purification treatment of each apartment unit.

After treatment, the following procedure was recommended: (13) independent post-treatment testing and analysis for each apartment unit; (14) providing each apartment unit with a NASA Space Certified surface/air purifier unit for continued protection; and (15) providing each apartment unit with a NASA Space Certified HVAC-air purifier unit for continued protection. For example, for continued protection, a SANTUAIRY and GUARDIAN AIR, both available from BEYOND BY AERUS, may be incorporated into each apartment unit.

### Example 5

Another experimental case study of the heat treatment method was performed at in a structure that was affected by Hurricane Harvey. The pre- and post-treatment data is shown in Tables 2 and 3.

TABLE 2
Organism Data from Example 5

| | | Spores/M³ | Spores/M³ |
|---|---|---|---|
| | Spores/M³ | (inside back | (inside office |
| Fungi ID | (outside control) | area) | east) |
| penicillium/aspergillus- | 595 | 3,250 | 1,790 |
| pre-treatment level | | | |
| penicillium/aspergillus- | 450 | 90 | 65 |
| post-treatment level | | | |

TABLE 3
Moisture Data from Example 5

| Moisture Content | percentage |
|---|---|
| pre-treatment level | 32% |
| post-treatment level | Less than 15% |

As is evident from Tables 2 and 3, the present method successfully reduced the organism and spore levels.

FIGS. 4A-4J list some organism/pathogens that may be killed using the present method, some of which may overlap with those listed in FIGS. 1A-1I.

### EMBODIMENTS

Some embodiments include a method of heat treating a structure using microturbine heater technology, with or without the use of environmentally friendly chemical additives; air purifying technologies such as active pure technology, UV or ionization technologies; or other technologies. In some such embodiments, a static pressure ranging from 1-20 inches is provided, which allows positive air flow to penetrate behind walls and into porous materials in the structure. In some such embodiments, the method is carbon neutral, and provides 1,400,000 BTUs. In some such embodiments, a 185 degrees Fahrenheit temperature rise is achieved at 0 degrees Fahrenheit reducing moisture faster than traditional methods. That is, when ambient temperature is 0 degrees Fahrenheit, the heat source disclosed herein can heat the air within the structures to 185 degrees Fahrenheit within a time frame of less than 5 minutes, or less than 3 minutes, or less than 1 minute. Thus, the microturbines are capable of rising the temperature within a structure to the thermal death point in a time of from 1 to 5 minutes, such as a temperature rise of from 120 to 200 degrees Fahrenheit in a time of from 1 to 5 minutes in a structure that is 3,000 square feet, for example. Systems that require more time to raise the temperature within a structure than is required by the present system can initiate sporulation of organisms, such as mold, within the structure. That is, the organisms can react to the slowly rising temperature by rapidly reproducing and releasing spores. The present system is capable of raising the temperature within the structure at a rate that prevents or reduces the occurrence of such sporulation. In some such embodiments, clean, flameless heat dries the facility to less than 19% moisture content (absolute humidity) or a relative humidity less than 50%. In some such embodiments, the method kills microorganisms such as fungi, bacteria, viruses, and pests. In some such embodiments, a mobile unit is used to carry out the method.

Some embodiments include a method of heat treating a structure using magnetic heat technology, alone or in combination of microturbine heater technology, environmentally friendly chemical additives; air purifying technologies such as active pure technology, UV or ionization technologies; or other technologies.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of drying a structure and of killing organisms within the structure, the method comprising:
providing heated air into a structure, wherein prior to providing the heated air into the structure, the structure has a first moisture level and a first concentration of organisms or spores;
maintaining the heated air within a first temperature range within the structure for a first time period; and
ceasing the provision of the heated air into the structure, wherein, after ceasing the provision of the heated air into the structure, the structure has a second moisture level and a second concentration of organisms or spores, wherein the second moisture level is lower than the first moisture level, and wherein the second concentration of organisms or spores is lower than the first concentration of organisms or spores.

2. The method of claim 1, wherein the organisms or spores include mold and spores thereof, insects, bacteria, viruses, fungi, yeast, helminths, protozoa, or combinations thereof.

3. The method of claim 1, wherein the heated air is provided from exhaust of a turbine engine.

4. The method of claim 3, wherein the heated air is provided from exhaust of a microturbine engine.

5. The method of claim 1, wherein the heated air is heated using an induction heater.

6. (canceled)

7. The method of claim 1, wherein the heated air is formed using a microturbine engine, wherein the microturbine engine has a heat output equivalent to from 800,000 to 1,400,000 BTU.

8. The method of claim 1, wherein the heated air is provided into the structure at a rate of from a 3200 cubic feet per minute (CFM) to 5200 CFM.

9. The method of claim 1, wherein the heated air is at least 120° F. and the first time period is at least 30 minutes.

10. The method of claim 1, wherein the first temperature range is from 100° F. to 300° F.

11. The method of claim 1, wherein the first time period is from 2 hours to 48 hours.

12. The method of claim 1, further comprising providing a turbulent flow of the heated air within the structure.

13. The method of claim 12, wherein providing the turbulent flow includes operating one or more fans within the structure.

14. The method of claim 1, further comprising, prior to providing the heated air into the structure, removing one or more items, animals, or plants from the structure, providing a heat barrier to one or more articles within the structure, moving one or more articles at least 1 foot away from walls within the structure, or combinations thereof.

15. The method of claim 1, further comprising providing a flow path to within an interior space of walls within the structure.

16. The method of claim 1, wherein, during the provision of the heated air, no flame is present within the structure.

17. (canceled)

18. The method of claim 1, further comprising monitoring a temperature of the structure during the providing of the heated air, monitoring a moisture content of the structure during the providing of the heated air, or combinations thereof.

19. The method of claim 1, wherein, prior to providing the heated air, a moisture content of the structure is greater than 19% humidity, and wherein, after providing the heated air, a moisture content of the structure is less than 19% humidity.

20. The method of claim 1, wherein, prior to providing the heated air, a relative humidity of the structure is greater than 50%, and wherein, after providing the heated air, a relative humidity of the structure is less than 50%.

21. The method of claim 1, further comprising, after providing the heated air, cooling the structure.

22. A system for drying a structure and killing organisms within the structure, the system comprising:
a source of heated air;
a conduit, the conduit configured to couple with a structure, wherein the conduit is in fluid communication with the source of heated air and is configured to receive heated air from the source of heated air and provide the heated air into the structure.

23. (canceled)

24. (canceled)

25. (canceled)

26. (canceled)

27. (canceled)

28. (canceled)

29. (canceled)
